(19) United States
(12) Patent Application Publication
(10) Pub. No.: US 2008/0062484 A1
(43) Pub. Date: Mar. 13, 2008

(54) Image processing device and image processing method

(76) Inventors: Hidekuni Moriya, Suwa-shi (JP); Nobutaka Sasazawa, Kagoshima-shi (JP); Masanori Ishida, Kagoshima-shi (JP); Keiko Shiohara, Shiojiri-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/899,672

(22) Filed: Sep. 6, 2007

(30) Foreign Application Priority Data
Sep. 12, 2006 (JP) 2006-246966
Jul. 2, 2007 (JP) 2007-173870

(51) Int. Cl. H04N 1/46

(52) U.S. Cl. 358/534; 358/530

(57) ABSTRACT

An image processing device connected to a display device and a printing device, the image processing device includes an image data acquiring module that acquires image data; a setting module that sets a print image quality adjustment condition that is a condition for adjusting image quality for a print image; a print image data generating module that performs a image quality adjustment process on the acquired image data on the basis of the set print image quality adjustment condition, and generates print image data; a display image data generating module that performs a image quality adjustment process on the acquired image data on the basis of the set print image quality adjustment condition, and generates display image data; a display image adjusting module that adjusts the display image data so as to conform or approximate characteristics of a display image reproduced by the display device using the display image data to characteristics of a print image reproduced by the printing device using the print image data; and a display control module that displays an image on the display device, using the adjusted display image data.

### CROSS REFERENCE TO RELATED APPLICATION

This application relates to and claims priority from Japanese Patent Applications No. 2006-246966, filed on Sep. 12, 2007, and No. 2007-173870, filed on Jul. 2, 2007, the entire disclosures of which are incorporated by reference.

### BACKGROUND

1. Technical Field

The present invention relates to an image processing device for carrying out image processing of image data, and to an image processing method for image data.

2. Related Art

It is common knowledge that where identical image data is used, the color of a display image displayed on a display device and the color of a print image printed onto printer paper may not match, due to the different reproduction characteristics of the display device and the printing device. Technology to address this problem, adapted to make the color of print images and the color of display images visually match one another have been developed.

However, there are various possible reasons why a user might wish to display a display image on a display device: for example, in order to check the subject and composition of an image, or to check the effects of an image quality adjustment. It is known that color matching processes for making the color of print images and the color of display images visually match one another are typically time-consuming, and require relatively high levels of processing resources. Particularly in the case of printing devices of standalone type that currently enjoy widespread use, in many instances the lack of adequate processing resources will mean that carrying out a color matching process will in some cases result in inability to meet user requirements for a fast printing process and so on. Accordingly, it would be desirable to execute display processes and printing processes with image data, in a manner consistent with the requirements of the user.

With the foregoing in view, there is need to enable display on a display device of a display image visually conforming or approximating to a print image, in accordance with the requirements of the user.

### SUMMARY

In order to address this issue at least in part, the present invention in a first aspect provides an image processing device for connection to a display device and a printing device. The image processing device pertaining to the first aspect includes: an image data acquiring module that acquires image data; a setting module that sets a print image quality adjustment condition that is a condition for adjusting image quality of a print image; a print image data generating module that performs a image quality adjustment process on the acquired image data on the basis of the set print image quality adjustment condition, and generates print image data; a display image data generating module that performs a image quality adjustment process on the acquired image data on the basis of the set print image quality adjustment condition, and generates display image data; a display image adjusting module that adjusts the display image data so as to conform or approximate characteristics of a display image reproduced by the display device using the display image data o characteristics if a print image reproduced by the printing device using the print image data; and a display control module that, displays an image on the display device, using the adjusted display image data.

The image processing device pertaining to the first aspect of the present invention is provided with a display image adjusting module that adjusts the display image data so as to conform or approximate characteristics of a display image reproduced by the display device using the display image data to characteristics of a print image reproduced by the printing device using the print image data, therefore it will be possible to display a display image that is visually conforming or approximating to the print image, in accordance with the requirements of the user.

In the image processing device pertaining to the first aspect of the present invention, adjustment of the display image data by the display image adjusting module may be performed in the event that printed results confirmation display has been requested. In such instances it will be possible to display a display image conforming or approximating to the print image, in accordance with the requirements of the user.

In the image processing device pertaining to the first aspect of the present invention, in the event that printed results confirmation display is not requested, the display image data generating module may generate unadjusted display image data, without image quality adjustment on the basis of the set print image quality adjustment condition; and the display control module may display an image on the display device using the unadjusted display image data. Image display on the display device will be accelerated thereby.

In the image processing device pertaining to the first aspect of the present invention, in the event that printed results confirmation display is not requested, the display control module may display an image on the display device, using the generated display image data. Using image data that has undergone an image quality adjustment process, image display on the display device will be accelerated thereby.

In the image processing device pertaining to the first aspect of the present invention, the print image quality adjustment condition may include an automatic image quality adjustment condition adapted to conform or approximate a characteristic of a print image to a standard characteristic, or a manual image quality adjustment condition arbitrarily adjusting a characteristic of a print image; and adjustment of the display image data by the display image adjusting module may be performed in the event that either the automatic image quality adjustment condition or the manual image quality adjustment condition has been set, and printed results confirmation display has been requested. In such instances it will be possible to display a display image visually conforming or approximating to the print image in accordance with the requirements of the user, using image data that has undergone an image quality adjustment process in accordance with a print image quality adjustment condition.

In the image processing device pertaining to the first aspect of the present invention, adjustment by the display image adjusting module may involve a color matching process for conforming or approximating bringing gray balance of the display image to gray balance of the print image. It will thus be possible for color reproduction of a display image and color reproduction of a print image to be conformed or approximated to one another.

In the image processing device pertaining to the first aspect of the present invention, adjustment by the display image adjusting module may be performed in a manner depending on the print paper used in the printing device. It will be possible thereby to conform or approximate color reproduction of a display image to color reproduction of a print image.

The image processing device pertaining to the first aspect of the present invention may also include a printing control module that, in the event a print request is detected, uses the print image data generated by the print image data generating module, to print an image from the printing device. It will be possible thereby to generate print image data and perform printing, when a print request has been issued.

In the image processing device pertaining to the first aspect of the present invention, the image processing device may be integrally furnished with the display device and the printing device. It will be possible thereby to carry out display of display images and printing of print images, with a single image processing device.

The present invention in a second aspect provides an image processing method for image data. The image processing method pertaining to the second aspect of the present invention includes acquiring image data; acquiring a print image quality adjustment condition that is a condition for image quality adjustment of a print image; on the basis of the acquired print image quality adjustment condition, performing a image quality adjustment process on the acquired image data and generating display image data; adjusting the display image data in order to conform or approximate the characteristics of a display image reproduced by the display device using the display image data to characteristics of a print image reproduced by the printing device using print image data that has been derived by applying the acquired print image quality adjustment condition to the acquired image data; and using the adjusted display image data to display an image on a display device.

The image processing method pertaining to the second aspect of the present invention affords advantages similar to those of the image processing device pertaining to the first aspect of the present invention. Like the image processing device pertaining to the first aspect of the present invention, the image processing method pertaining to the second aspect of the present invention may assume various embodiments. The image processing method pertaining to the second aspect of the present invention may be embodied as a computer program, or as a computer program recorded on a computer-readable medium such as a CD, DVD, or HDD.

### BRIEF DESCRIPTION OF THE DRAWINGS

The image processing device and image processing method which pertain to the present invention will be described hereinbelow through certain preferred embodiments, with reference to the accompanying drawings, wherein:

FIG. 1 is an illustration depicting schematically the exterior design of a printer pertaining to first embodiment;

FIG. 2 is a function block diagram depicting schematically the functional configuration of the printer pertaining to first embodiment;

FIG. 3 is an illustration depicting an image processing program executed in the printer pertaining to first embodiment;

FIG. 4 is a flowchart depicting the processing routine of image processing executed by the printer pertaining to first embodiment;

FIG. 5 is an illustration depicting an exemplary display screen displayed on the display unit when setting image quality adjustments;

FIG. 6 is a flowchart depicting the processing routine of a display control process with a preview process, executed by the printer pertaining to first embodiment;

FIG. 7 is an illustration depicting an exemplary brightness histogram obtained by analysis of image data;

FIG. 8 is an illustration conceptually depicting an exemplary method for detecting a facial region during analysis of image data;

FIG. 9 is an illustration of an exemplary tone curve used for bringing skin tone into approximation with acceptable skin tone;

FIG. 10 is an illustration of an exemplary tone curve of the R component adjusted for the purpose of the display adjustment process;

FIG. 11 is an illustration of an exemplary tone curve of the G component adjusted for the purpose of the display adjustment process;

FIG. 12 is an illustration of an exemplary tone curve of the B component adjusted for the purpose of the display adjustment process;

FIG. 13 is an illustration of an exemplary tone curve of the R component adjusted through both automatic image quality adjustment and the display adjustment process;

FIG. 14 is a flowchart depicting the processing routine of a display control process without a preview process, executed by the printer pertaining to first embodiment;

FIG. 15 is a flowchart depicting the processing routine of a printing control process executed by the printer pertaining to first embodiment;

FIG. 16 is an illustration of an exemplary display screen for setting an image effect by way of an image adjustment setting;

FIG. 17 is an illustration of an exemplary display screen for setting contrast by way of an image adjustment setting;

FIG. 18 is an illustration of an exemplary tone curve used during contrast correction;

FIG. 19 is an illustration of an exemplary display screen for setting lightness by way of an image adjustment setting;

FIG. 20 is an illustration of an exemplary tone curve used during lightness correction;

FIG. 21 is an illustration of an exemplary display screen for setting saturation by way of an image adjustment setting;

FIG. 22 is an illustration depicting the concept of saturation correction using a color wheel;

FIG. 23 is an illustration of an exemplary display screen for setting sharpness by way of an image adjustment setting;

FIG. 24 is an illustration of the procedure of sharpness correction;

FIG. 25 is an illustration of the procedure of sharpness correction;

FIG. 26 is an illustration of the procedure of sharpness correction;

FIG. 27 is an illustration of the procedure of sharpness correction;

FIG. 28 is a flowchart depicting the processing routine of a display control process with a preview process, executed in second embodiment;

FIG. 29 is a flowchart depicting the processing routine of a printing control process executed in second embodiment;

FIG. 30 is an illustration depicting a configuration example of a system in which a PC and a printer are connected;

FIG. 31 is an illustration depicting a system configuration example in a first alternative embodiment;

FIG. 32 is a flowchart depicting the processing routine of image processing executed in the PC in the first alternative embodiment;

FIG. 33 is an illustration depicting a system configuration example in a second alternative embodiment; and

FIG. 34 is a flowchart depicting the processing routine of image processing executed in an independent display device in the second alternative embodiment.

### DESCRIPTION OF EXEMPLARY EMBODIMENTS

### First Embodiment

### Configuration of Image Processing Device

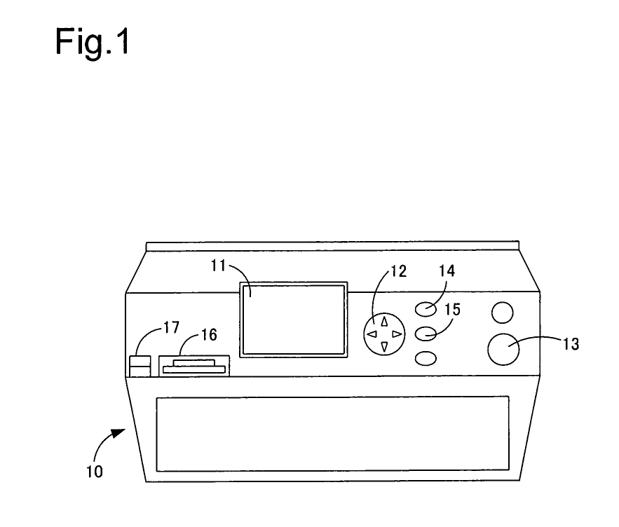

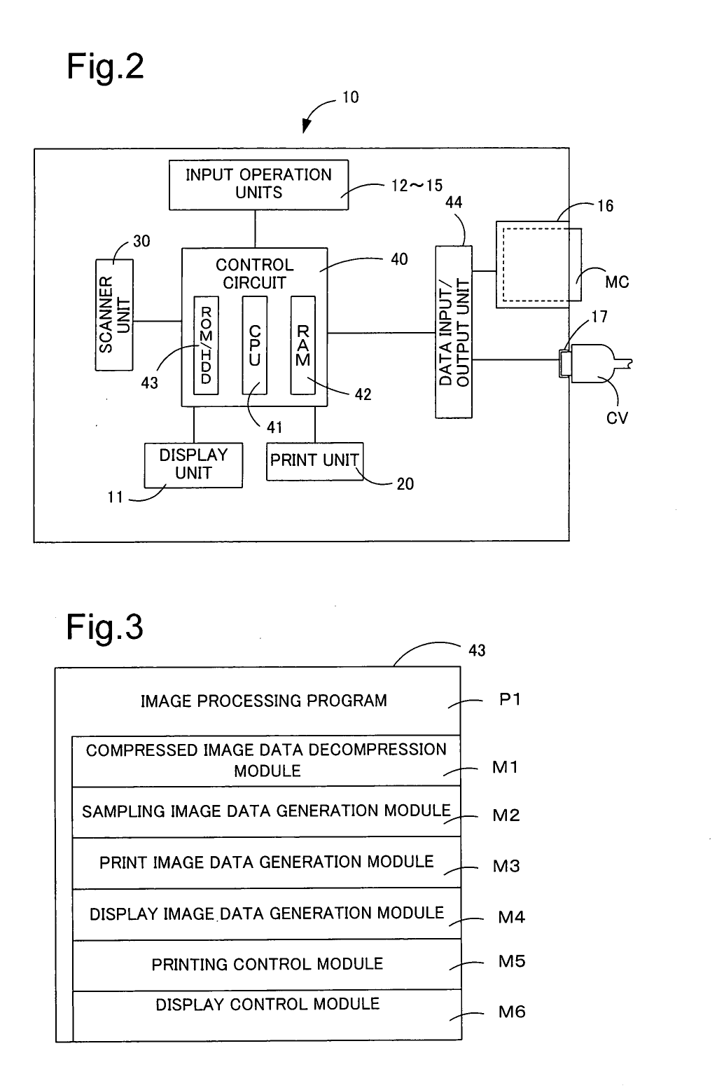

In the embodiment hereinbelow, a multifunction, standalone type printer having a scanner function and a printing function will be described by way of an exemplary image processing device. The configuration of the printer pertaining to the present embodiment will be described with reference to FIGS. 1 to 3. FIG. 1 is an illustration depicting schematically the exterior design of a printer pertaining to first embodiment. FIG. 2 is a function block diagram depicting schematically the functional configuration of the printer pertaining to first embodiment. FIG. 3 is an illustration depicting an image processing program executed in the printer pertaining to first embodiment.

The configuration of the printer 10 pertaining to first embodiment will be discussed with reference to FIG. 1, focusing on the configuration of the control panel. The printer 10 is a multifunction, standalone type printer having a scanner function and a printing function, and does not require a connection to a PC; the device is capable of scanning original documents, printing data, and copying original documents. The printer 10 includes a display unit 11, a select key 12, a print key 13, an execute key 14, a preview display key 15, a memory card slot, and an external device connection terminal 17.

The display unit 11 is used display of display images of image data targeted print; and display of settings which have been made, for the purpose of making various settings to be executed by the printer 10. In the present embodiment, as the initial screen subsequent to printer startup, there will be displayed a menu screen that includes image display, printing parameter settings, and image selection. Example of printing condition that can be set via the display unit 11 are the specifics of image quality adjustment of image data, layout of the print image, type of print paper used print, and number of pages print. As the display unit 11 there could be employed, for example, a color liquid crystal display unit, color organic electroluminescent display unit, CRT, or plasma display.

The select key 12 is designed, for example, to be toggleable down left, right, up and down about a center axis, and is used to select settings items displayed on the display unit 11, as well as to select print image data from among image data stored on a memory card, by means of selecting an image on the display unit 11. For example, where settings items have been nested in multiple levels, it would be possible to sequentially select items by toggling the select key 12 up or down, or to display (select) sub-menu items under a selected item by toggling the select key 12 left or right. Alternatively, in the case of selecting print image data, it would be possible to sequentially select folders by toggling the select key 12 up or down, to display (select) image data contained in a selected folder by toggling the select key 12 left or right.

The print key 13 enables the user to input a print instruction. As long as the image data targeted print is that currently displayed on the display unit 11, a print instruction input by means of the print key 13 may be an instruction permitted to interrupt any other processes currently being executed. Alternatively, even where the image data targeted print is not that currently displayed on the display unit 11, it would be acceptable, when the print key 13 is pressed, to execute an index printing process using all of the image data contained in the memory card installed in the memory card slot 16.

The execute key 14 enables the user to input an instruction to select an item that has been selected with the select key 12, or to select a settings value that has been selected with the select key 12. For example, with a lower nesting level item selected, the selected item could be confirmed by pressing the execute key 14.

The preview display key 15 is used to select whether to show or hide a preview image that reflects a preset print image quality adjustment process; and to select or deselect display of a real preview image that displays color reproduction of the display image when the image has been brought into agreement with or close approximation to color reproduction of the print image. In the initial state subsequent to starting up the printer 10, the preview display setting will be “Hide.” If the preview display key 15 is pressed once, a normal preview image will be shown on the display unit 11. With the normal preview image displayed, if the preview display key 15 is pressed again, a real preview image will be displayed on the display unit 11. With the real preview image displayed on the display unit 11, if the preview display key 15 is pressed again, an original image which has not been subjected to the print image quality adjustment process will be displayed on the display unit 11.

A real preview image is an image displayed on the display unit 11 once target image data having undergone a print image quality adjustment process, or not having undergone a print image quality adjustment process, has been subjected to a display adjustment process to bring color reproduction of the display image into agreement with or close approximation to color reproduction of the print image. A preview image is an image that has undergone a print image quality adjustment process, but not a display adjustment process. An original image is an image that has undergone neither a print image quality adjustment process nor a display adjustment process; for example, one displayed on the display unit using original data stored on the memory card.

The memory card slot 16 is a memory attachment portion of multi-slot type permitting memory cards of various formats to be attached.

The external device connection terminal 17 is a terminal for connecting, via a connector cable, an external device such as a digital still camera or digital video camera, or for connecting the printer 10 via a connector cable to a PC to be used as an external device. The terminal could be compliant with various interface standards such as Universal Serial Bus (USB) or IEEE 1394.

The functional configuration of the printer 10 pertaining to first embodiment will be discussed with reference to FIG. 2. The printer 10 includes the display unit 11, the input operation units 12 to 15, the memory card slot 16, the external device connection terminal 17, a print unit 20, a scanner unit 30, a control circuit 40, and a data input/output unit 44.

The display unit 11, the input operation units 12 to 15, the memory card slot 16, the external device connection terminal 17 have been discussed already and will be omitted from the present discussion.

The print unit 20 executes a color printing process on the basis of print data. The print unit 20 is equipped with a print engine, for example, of ink-jet type, laser type, or dye sublimation type; and with a paper feed function for transporting the print paper. The print data includes, in addition to actual print image data, print control commands that control the printing process.

The scanner unit 30 uses a photoelectric conversion element to scan a document targeted for scanning, and create image data that corresponds to the target document. The photoelectric conversion element could be a line-type CCD (charge coupled device), for example. A copier function can be achieved by using the image data created in the scanner unit 30 to output a print image from the print unit 20. That is, the printer 10 can acquire image data not only from a memory card or externally connected device, but also acquire image data internally from its scanner unit 30.

The control circuit 40 is connected via signal lines to the display unit 11, the input operation units 12 to 15, the print unit 20, the scanner unit 30, and the data input/output unit 44. The control circuit 40 receives instructions input from the input operation units 12 to 15, and performs processing, inclusive of an image quality adjustment process, on image data acquired via the data input/output unit 44; or generates image data of prescribed format from information scanned in bit units by the scanner unit 30. The control circuit 40 then outputs display image data inclusive of display image data obtained by performing a image quality adjustment on image data; or generates and outputs to the print unit 20 data display inclusive of print image data obtained by performing a image quality adjustment on image data.

The control circuit 40 includes a central processing unit (CPU) 41, a random access memory (RAM) 42, and a read-only memory (ROM) or hard disk drive (HDD) 43. The ROM or HDD 43 is a non-volatile storage device used to store various programs and execution modules for execution by the CPU 41. Either a ROM or HDD, or both, may be provided. The RAM 42 is a working volatile storage device used for execution of programs or for storing image data that is being processed. In the present embodiment, a display image data storage area that stores display image data, and a print image data storage area that stores print image data, are maintained as separate areas.

The data input/output unit 44 controls transfer of image data to and from a memory card MC or connector cable CV, via the memory card slot 16 and the external device connection terminal 17.

An image processing program stored in the ROM or HDD 43 will be described with reference to FIG. 3. To facilitate the description, FIG. 3 depicts in model form the image processing program P1 stored in the ROM or HDD 43.

The image processing program P1 includes a compressed image data decompression module M1 that decompresses (decodes) compressed image data acquired via the data input/output unit 44; a sampling image data generation module M2 that generates from the decompressed image data sampling image data to be used in image analysis; a print image data generation module M3 that performs preset print image quality adjustment on the decompressed image data and generating print image data; a display image data generation module M4 that performs preset print image quality adjustment on the decompressed image data and generating display image data; a printing control module M5 that generates print data; and a display control module M6 that generates display data.

The compressed image data decompression module M1 is a module for the purpose of decompressing (decoding) compressed image data (encoded image data) on the memory card, that has been targeted print or display. Typically, image data generated in a digital still camera will be YCbCr data, and will be compressed in the JPEG format. The compressed image data decompression module M1 decompresses the compressed JPEG data, and converts it from YCbCr data to RGB data to permit handling in the RGB color space in which image processing will be performed.

The sampling image data generation module M2 generates sampling image data to be used in image analysis, from the RGB image data provided by the compressed image data decompression module M1. Specifically, in order to reduce the pixel count targeted for analysis, the sampling image data generation module M2 performs an image data resolution conversion process, termed a pixel skipping process, and generates image data with a smaller pixel count.

The print image data generation module M3 generates print image data by performing an image quality adjustment process and a resolution conversion process in accordance with print setting parameters set print purposes, on the RGB image data provided by the compressed image data decompression module M1.

The display image data generation module M4, while either performing a image quality adjustment process in accordance with print setting parameters set print purposes on the RGB image data provided by the compressed image data decompression module M1 in the event a preview request has been made, or not performing a image quality adjustment process in the event a preview request has not been made, performs a resolution conversion process to match the resolution (display pixel count) of the display unit 11, to generate display image data for use in preview image display or original image display.

The printing control module M5 functions as a so-called printer driver; it performs a halftoning process and an RGB-CMYK conversion process (conversion process to the color space of the output device) on the print image data generated by the print image data generation module M3 and appends a print control command interpretable by the print unit 20, to generate the print data.

The display control module M6 functions as a so-called display driver, it appends to the display image data generated by the display image data generation module M4 a display control command that is interpretable by the display unit 11, to generate data display. In the present embodiment, in the event that real preview display has been selected, the display control module M6 will additionally perform on the display image data a display adjustment process for the purpose of bringing color reproduction of the display image into agreement with or close approximation to color reproduction of the print image.

Image Processing:

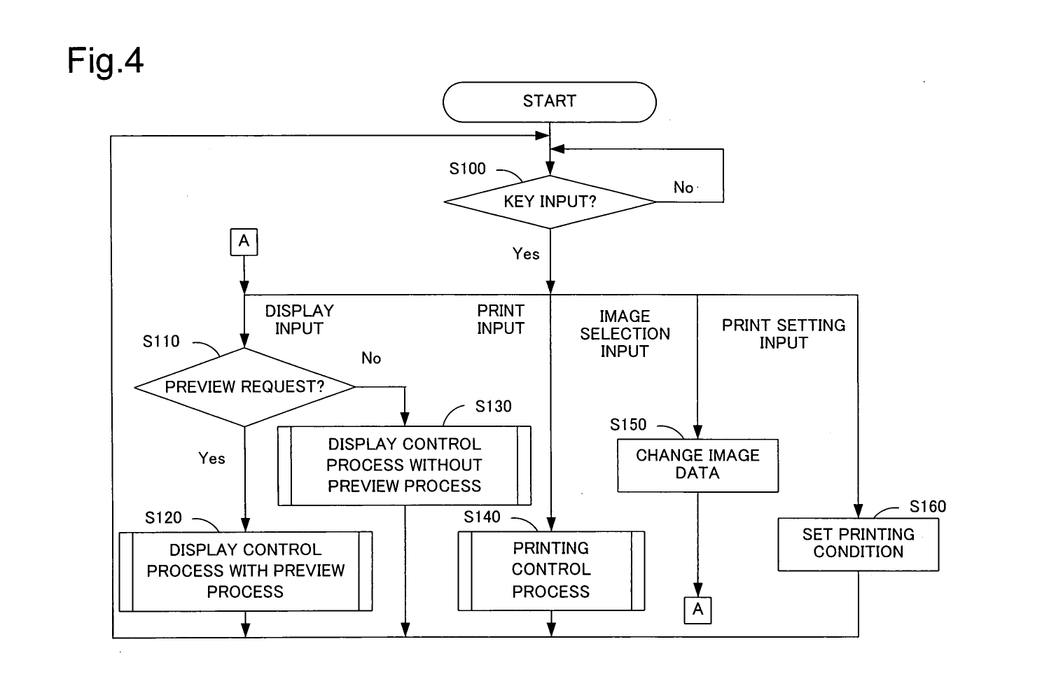

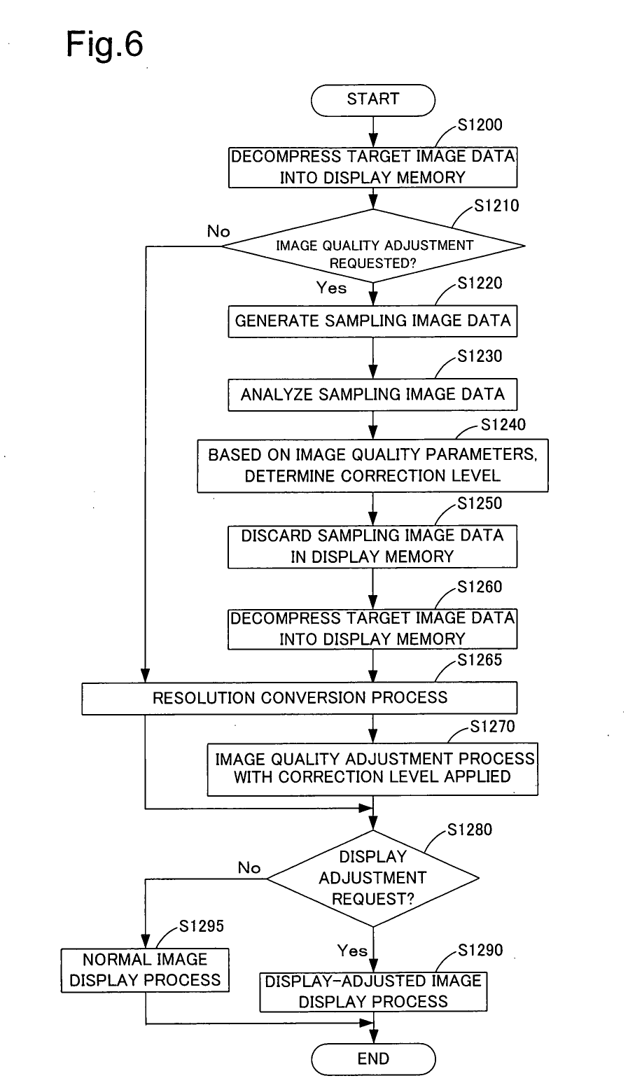

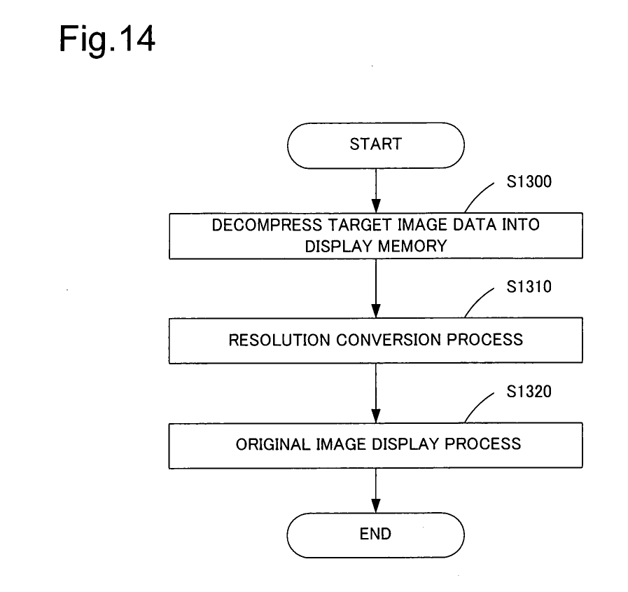

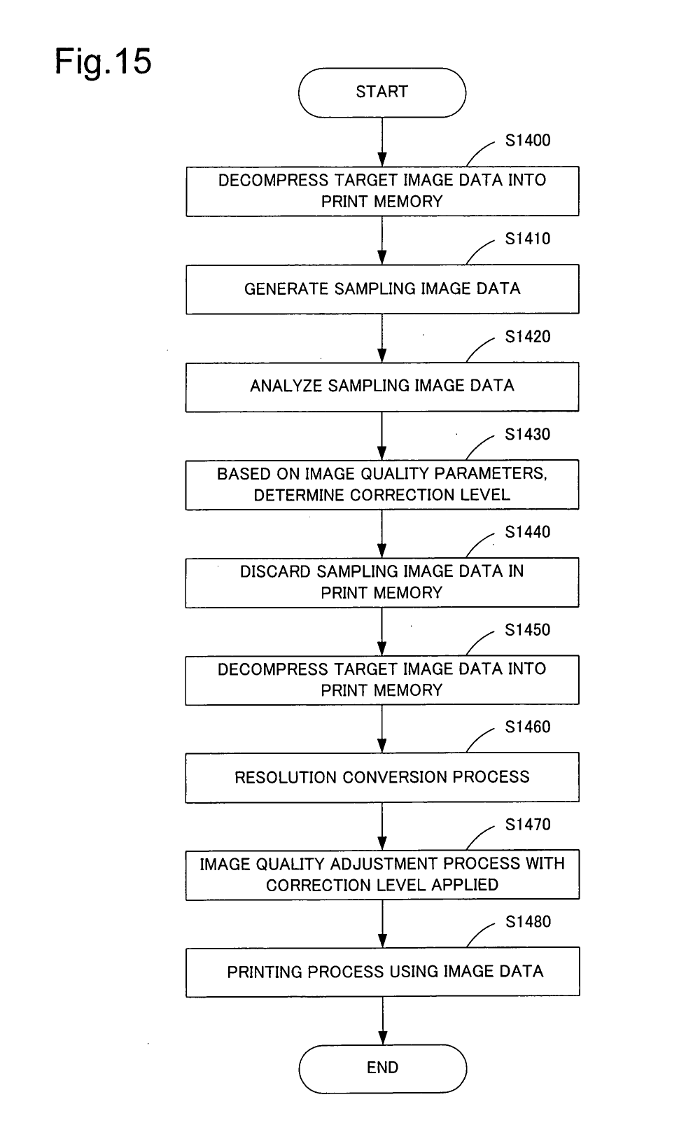

The image processing carried out by the printer 10 pertaining to the present embodiment will be described with reference to FIGS. 4 through 15. FIG. 4 is a flowchart depicting the processing routine of image processing executed by the printer pertaining to the present embodiment. FIG. 6 is a flowchart depicting the processing routine of the display control process with a preview process, executed by the printer pertaining to the present embodiment. FIG. 14 is a flowchart depicting the processing routine of the display control process without a preview process, executed by the printer pertaining the present embodiment. FIG. 15 is a flowchart depicting the processing routine of a printing control process executed by the printer pertaining to the present embodiment. These image processes are accomplished through appropriate execution of the image processing program P1 and the modules M1 through Mb by the CPU 41.

When the image processing routine is initiated, the CPU 41 awaits key input (Step S100: No). When the CPU 41 detects key input via one of the input operation units 12 to 15 (Step S100: Yes), CPU 41 decides whether the input is an image display request made via the select key 12, a print request made via the print key 13, an image select request made via the select key 12, or a print parameter setting made via the select key 12.

In the event that the input is an image display request made via the select key 12, the CPU 41 decides whether a preview display request has been made (Step S110). As mentioned previously, the CPU 41 decides whether there is a preview display request, depending on whether the preview display key has been pressed. In the event that the CPU 41 decides that a preview display request has been made (Step S110: Yes), CPU 41 executes the display control process with a preview process (Step S120). The display control process with a preview process will be discussed later with reference to FIG. 6.

On other hand, in the event that the CPU 41 decides that a preview display request has not been made (Step S110: No), CPU 41 executes the display control process without a preview process (Step S130). The display control process without a preview process will be discussed later with reference to FIG. 14.

In the event that the input is a print request made via the print key 13, the CPU 41 executes a print control process (Step S140). The print control process will be discussed later with reference to FIG. 15.

In the event that the input is an image select request made via the select key 12, the CPU 41 changes the image data targeted display to the selected image data (Step S150), and then execute the same process as that when an image display request is input (A).

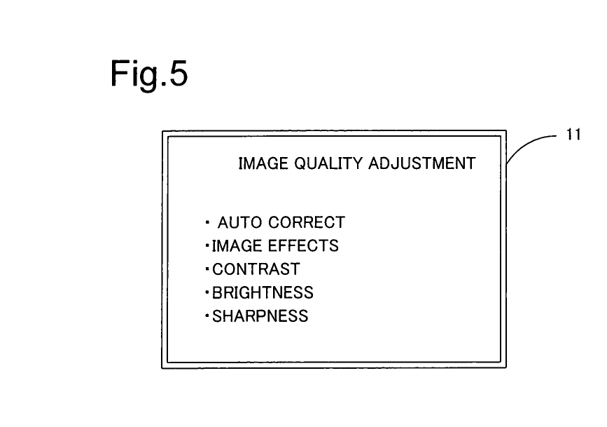

In the event that the input is a print parameter setting made via the select key 12, the CPU 41 sets the print parameters (Step S160) and returns to Step S100. The procedure for setting print parameters will be described with reference to FIG. 5. FIG. 5 is an illustration depicting an exemplary display screen displayed on the display unit when setting image quality adjustments. When “Print Parameter Settings” is selected via the select key 12 from the initial menu screen displayed on the display unit 11, the image quality adjustment menu depicted in FIG. 5 will be displayed on the display unit 11. In the present embodiment, an automatic image quality adjustment process will be described by way of the image quality adjustment process. By selecting “Auto Correct” using the select key 12 and then pressing the execute key 14, the automatic image quality adjustment process is selected as a printing parameter.

The automatic image quality adjustment process is a image quality adjustment process that involves analyzing the image data targeted for processing; calculating a characteristic quantity (statistical value), for example, an RGB histogram, brightness histogram, maximum/minimum brightness value, or average lightness; and on the basis of the calculated characteristic quantity, conforming or approximating the RGB components and brightness component of the image data to standard values (correction target values) that have been predetermined on the basis of desirable image data characteristic quantities. In the image quality adjustment process, RGB tone values are adjusted, for example, using tone curves for the individual R, G, B components or an RGB tone curve, or using an RGB histogram, to adjust the tone level of the image data.

Display Control Process with Preview Process

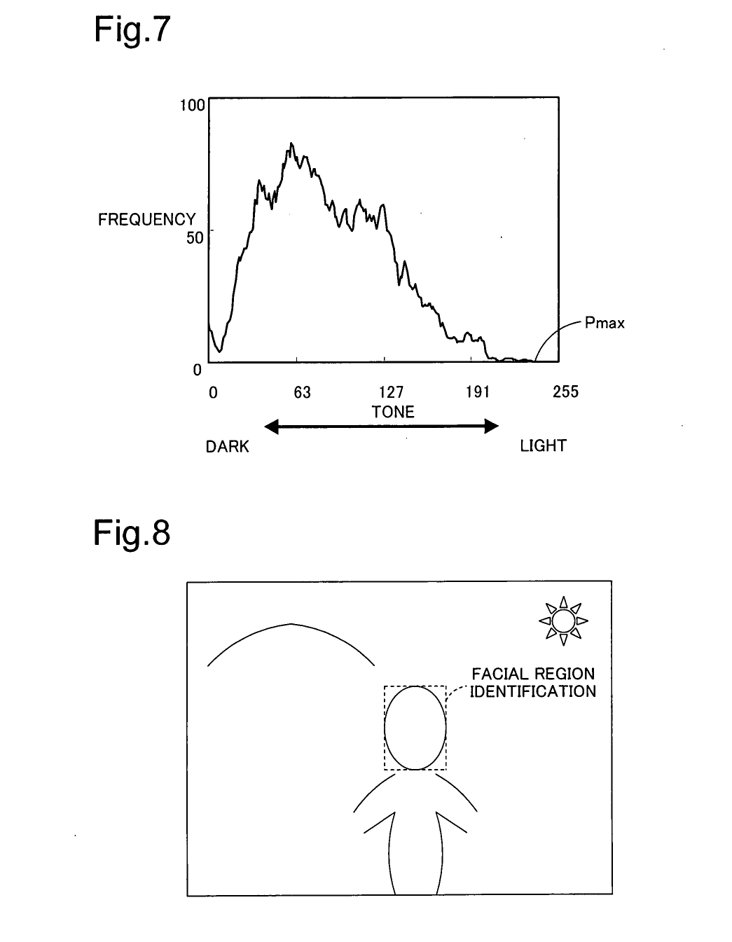

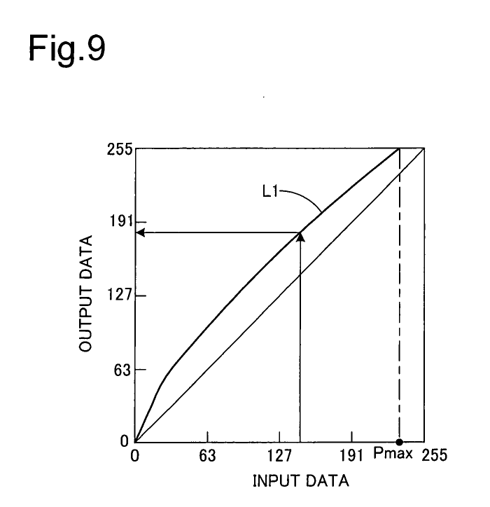

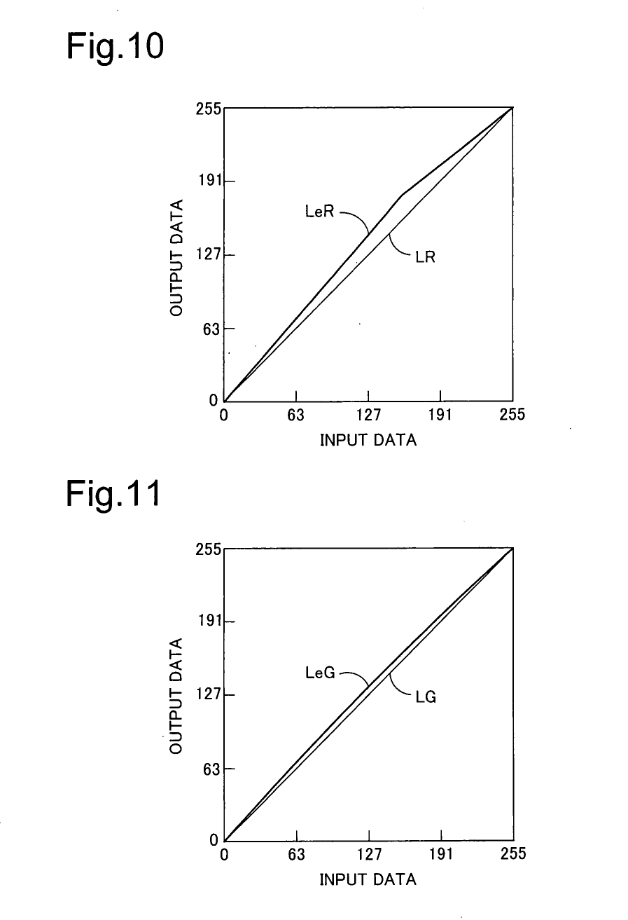

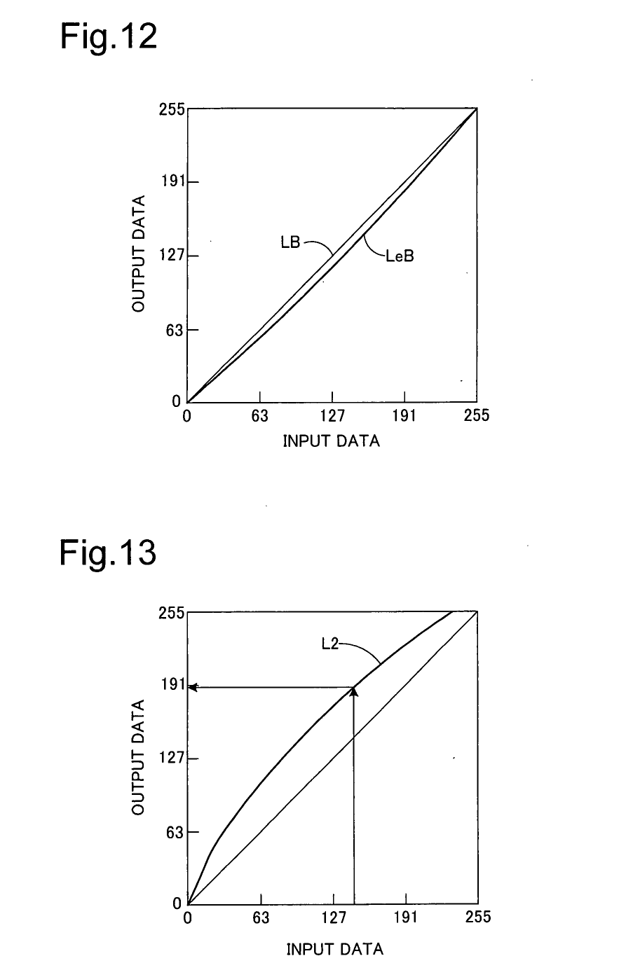

The display control process with a preview process will be described with reference to FIGS. 6 through 13. FIG. 7 is an illustration depicting an exemplary brightness histogram obtained by analysis of image data. FIG. 8 is an illustration conceptually depicting an exemplary method for detecting a facial region during analysis of image data. FIG. 9 is an illustration of an exemplary tone curve used for bringing skin tone into approximation with acceptable skin tone. FIG. 10 is an illustration of an exemplary tone curve of the R component adjusted for the purpose of the display adjustment process. FIG. 11 is an illustration of an exemplary tone curve of the G component adjusted for the purpose of the display adjustment process. FIG. 12 is an illustration of an exemplary tone curve of the B component adjusted for the purpose of the display adjustment process. FIG. 13 is an illustration of an exemplary tone curve of the R component adjusted through both automatic image quality adjustment and the display adjustment process.

The CPU 41 acquires from the memory card a copy of the image data targeted for processing, stores the data in the display image data storage area, and decompresses it (Step S1200). Specifically, by means of executing the compressed image data decompression module M1, the CPU 41 decodes the JPEG-format compressed YCbCr data into expanded YCbCr data in the display image data storage area; then performs γ correction and a color conversion process employing a YCbCr-RGB conversion table, to convert the YCbCr data to RGB data.

The CPU 41 then decides whether image quality adjustment has been requested (Step S1210), and if the CPU 41 decides that image quality adjustment has been requested (Step S1210: Yes), generates sampling image data (Step S1220). On the other hand, if the CPU 41 decides that image quality adjustment has not been requested (Step S1210: No), the CPU 41 proceeds to Step S1280, via a Step S1265 in which a resolution conversion process to match the resolution of the display unit 11 is performed.

In the present embodiment, the CPU 41 decides whether image quality adjustment has been requested in instances where, in the printing parameter settings items, the image quality adjustment setting has been set to either the automatic image quality adjustment or the manual image quality adjustment setting discussed previously. Specifically, image quality adjustment will be performed according to the preset printing conditions, even where the image data is intended display on the display unit 11. In the present embodiment, in the printing condition settings items, the image quality adjustment setting has been set to automatic image quality adjustment.

By means of executing the sampling image data generation module M2, the CPU 41 performs a resolution conversion process involving pixel thinning, to reduce the pixel data count of the decompressed image data in the display image data storage area, and generates sampling image data.

The CPU 41 then analyzes the sampling image data, and acquires a characteristic quantity of the target image data (Step S1230). Specifically, the CPU 41 executes the display image data generation module M4 and calculates statistical values for the sampling image data, namely, an RGB histogram and the brightness histogram shown in FIG. 7, as well as calculating characteristic quantities, namely, values or levels of the image quality parameters maximum brightness Pmax, minimum brightness, lightness, color saturation, color balance, highlights, shadow, contrast, and sharpness.

The CPU 41 may additionally identify a facial region, using region shape and region color, as depicted in FIG. 8. In the example of FIG. 8, a pixel region that is generally oval in shape and that contains skin tone pixel values is identified as being a facial region. Other specific regions, namely mountains or sky, could also be identified with reference to combinations of color and size of pixel regions having the same given color.

The CPU 41 then determines correction levels for various image quality parameters which characterize the image data (Step S1240). Specifically, the CPU 41 executes the display image data generation module M4, and using the characteristic quantities of the various image quality parameters derived through analysis of the sampling image data, together with standard values that have been predetermined for these various image quality parameters, determines the correction levels. The standard values are target values for image quality adjustment that have been prepared using various image quality parameters belonging to images having desirable image quality. The correction levels are used for modifying the characteristics of tone curves so as to conform or approximate the values or levels of the various image quality parameters derived through analysis, to the standard values.

The CPU 41 then discards the sampling image data stored in the display image data storage area (Step S1250), executes the compressed image data decompression module M1 to again decompress the targeted image data into the display image data storage area (Step S1260), and performs a resolution conversion process (Step S1265). Typically, the resolution (pixel count) of image data generated by a digital still camera is greater than the resolution of the display unit 11 (display pixel count), and thus a conversion process to lower the image resolution will be performed. Specifically, pixel skipping is performed on the pixel data making up the image data, using a nearest neighbor method or straight-line approximation method.

A resolution conversion processes is necessary because the resolution (pixel count) required for the sampling image data and the resolution required display on the display unit 11 are different; however, performing resolution conversion repeatedly poses the risk of degrading the image. Accordingly, in the present embodiment, the CPU 41 again acquires from the memory card the display image data on the display unit 11 and again performs resolution conversion thereof, so as to prevent degradation of the image due to repeated resolution conversion.

The CPU 41 applies the determined correction levels to perform the image quality adjustment process on the target image data (Step S1270). Specifically, the CPU 41 executes the display image data generation module M4, applying the determined correction levels to modify the characteristics of the tone curves, and then using the characteristic-modified tone curves to generate display image data from the target image data. Modification of the tone curves is typically accomplished by applying a correction level to modify the output value for a specific input value; the specific input value (adjustment point) will differ depending on the parameter being corrected.

In the example of FIG. 9, there is employed an R component tone curve L1 adjusted for the purpose of making skin tone pixel values included in image data, into desirable skin tone pixel values. Specifically, output values corresponding to R component input values that correspond to skin tone are modified to R component output values that correspond to desirable skin tone, the maximum value Pmax of the input value (image data brightness value) is set to the maximum value of the output value, and the minimum and maximum R component corrected output values or output values corresponding to desirable skin tone are connected by a spline curve or the like, to give an adjusted tone curve. While only the R component is depicted in FIG. 9, tone curves would be adjusted in similar fashion for the G component and the B component as well.

The CPU 41 then decides whether a display adjustment process has been requested (Step S1280). Specifically, the CPU 41 decides whether real preview image display has been requested, depending on whether the preview display key has been pressed twice in the original image display mode, or pressed once in the preview display mode.

If the CPU 41 decides that a display adjustment process has been requested (Step S1280: Yes), the CPU 41 executes a real preview image display process involving performing a display adjustment process on display image data that has either undergone a image quality adjustment process or not undergone a image quality adjustment process (Step S1290). Specifically, the CPU 41 executes the display control module M6, applying the tone curves display adjustment process use depicted in FIGS. 10 through 12, on the display image data. The curves LeR, LeG, LeB shown in FIGS. 10 through 12 depict characteristic lines derived through correction of the pre-correction straight lines LR, LG, LB to match the color reproduction of a print image. Since a display image typically has more intense bluish tone in comparison with a print image, in the present embodiment, tone curves that hold down the B component and intensify the R and G components are used. In other words, the display adjustment process may be termed a color matching process that conforms or approximates the color balance of the display image to the color balance of the print image.

In the display adjustment process, in the event that the color space of the input data (the color space of the targeted image data) is the same as the color space of the output data (the color space of the image data subsequent to the image quality adjustment process), tone value correction may be carried out independently for the R, G and B components using the one-dimensional tables shown in FIGS. 10 through 12. If on the other hand the color space of the input data differs from the color space of the output data, a color conversion process that applies a three-dimensional lookup table to the RGB combinations that make up single pixel will be needed.

Where the display adjustment process is surely performed, or where real preview image display is combined with the image quality adjustment process, it would be acceptable to perform automatic image quality adjustment and the display adjustment process at the same time, using a tone curve L2 like that shown in FIG. 13 for example, derived by synthesizing the tone curve obtained automatically in automatic image quality adjustment with the tone curve used in the display adjustment process.

The tone curves depicted in FIGS. 10 through 12 are adjusted in such a way that calorimetric values of a displayed image on the display unit 11 are approximated or conformed to colorimetric values of a print image output by the print unit 20. During adjustment, adjustment is performed such that the white point (illuminant) of the display unit 11 is approximated or conformed to the white point (paper ground color) of the print paper.

If the CPU 41 decides that a display adjustment process has not been requested (Step S1280: No), CPU 41 performs an image display process using the display image data, then terminates the processing routine (Step S1295). Specifically, the CPU 41 executes the display control module M6 in order to generate display data using the display image data that has undergone a image quality adjustment process and display an image on the display unit 11.

Display Control Process without Preview Process

The display control process without a preview process will be described with reference to FIG. 14. The CPU 41 acquires from the memory card a copy of the image data targeted for processing, stores the data in the display image data storage area, and decompresses it (Step S1300). Specifically, by means of executing the compressed image data decompression module M1, the CPU 41 decodes the JPEG-format compressed YCbCr data into expanded YCbCr data in the display image data storage area; then performs γ correction and a color conversion process employing a YCbCr-RGB conversion table, to convert the YCbCr data to RGB data.

The CPU 41 then performs a resolution conversion process on the resultant RGB data (Step S1310). As mentioned previously, the resolution of image data generated by a digital still camera is typically greater than the resolution of the display unit 11, and thus a conversion process to lower the image resolution will be performed.

The CPU 41 performs an original image display process (Step S1320) using the RGB data that has undergone the resolution conversion process, terminates the processing routine. Specifically, in the display control process without a preview process, an image is displayed on the display unit 11, using original image data decompressed into the display image data storage area and generated through various conversion processes, without any sort of image quality adjustment process.

Printing Control Process

The printing control process will be described with reference to FIG. 15. Processes similar to process described previously in relation to the display control process will be discussed only in brief.

The CPU 41 acquires from the memory card a copy of the image data targeted for processing, stores the acquired data in the print image data storage area, and decompresses the stored data (Step S1400). Specifically, by means of executing the compressed image data decompression module M1, the CPU 41 decodes the JPEG-format compressed YCbCr data into expanded YCbCr data in the display image data storage area, then converts the expanded YCbCr data to RGB data using a YCbCr-RGB conversion table.

The CPU 41 generates sampling image data, for the purpose of performing automatic image quality adjustment which is the preset printing parameter (Step S1410). Specifically, the CPU 41 executes the sampling image data generation module M2, thereby performing a resolution conversion process involving thinning the pixel data count of image data that has been decompressed into the print image data storage area, to generate the sampling image data.

The CPU 41 analyzes the sampling image data and acquire characteristic quantities of the target image data (Step S1420). The specific method of analyzing the sampling image data has been discussed previously. In preferred practice, the resolution of the sampling image data generated when generating display image data the resolution of the sampling image data generated when generating print image data are the same, since it is desirable to obtain identical correction levels by way of the correction levels applied to the display image data and to the print image be identical. However, since the resolution of the display unit 11 is relatively low, the resolution of the sampling image data generated for the display image data may be set to below the resolution of the sampling image data generated for the print image data, so as to give priority to processing speed.

The CPU 41 determines correction levels for the various image quality parameters which characterize the image data (Step S1430). Specifically, the CPU 41 executes the print image data generation module M3, and using the characteristic quantities of the various image quality parameters derived through analysis of the sampling image data, together with standard values that have been predetermined for these various image quality parameters, determines the correction levels. The standard values are target values for image quality adjustment that have been prepared using various image quality parameters belonging to images having desirable image quality. The correction levels are used for modifying the characteristics of tone curves so as to conform or approximate the values or levels of the various image quality parameters derived through analysis, to the standard values.

The CPU 41 discards the sampling image data stored in the print image data storage area (Step S1440), executes the compressed image data decompression module M1 to again decompress the targeted image data into the print image data storage area (Step S1450), and performs a resolution conversion process (Step S1460). Typically, the resolution of image data generated by a digital still camera will be lower than the print resolution of the print unit 20, and thus a conversion process to expand the image resolution will be performed. Specifically, pixel data making up the image data will be added, using a nearest neighbor method or straight-line approximation method.

A resolution conversion processes is necessary because the resolution (pixel count) required for the sampling image data and the resolution required display on the print unit 20 are different; however, performing resolution conversion repeatedly poses the risk of degrading the image. Accordingly, in the present embodiment, the CPU 41 again acquires from the memory card the image data for output to the print unit 20 and again performs resolution conversion thereof, so as to prevent degradation of the image due to repeated resolution conversion.

The CPU 41 applies the determined correction levels to perform the image quality adjustment process on the target image data (Step S1470). Specifically, the CPU 41 executes the print image data generation module M3, applying the determined correction levels to modify the characteristics of the tone curves, and then using the characteristic-modified tone curves to generate print image data from the target image data.

The CPU 41 performs a printing process using the print image data, then terminates the processing routine (Step S1480). Specifically, the CPU 41, by executing the printing control module M5, performs a halftoning process and RGB-CMYK color conversion process on the print image data that has undergone an image quality adjustment process, then appends a print control command to generate print data used by the print unit 20 to print the image. The printing control process and the display control process may be executed in parallel, or executed when there is a display or print request.

According to the printer 10 which pertains to first embodiment discussed above, in the event that the user desires real preview display, the reproduction characteristics of the display image displayed on the display unit 11 may be conformed or approximated to the reproduction characteristics of the print image. Specifically, the visual appearance of the display image displayed on the display unit 11 and of the print image, e.g. the color balance or white balance, may be conformed or approximated to one another. As a result, from the display image displayed on the display unit 11, the user is able to inspect in advance the print image that will be obtained upon printing. Therefore, test printing to inspect the printed results is not necessary, and the desired printed results can be obtained without a laborious process involving repeated adjustment and printout.

Moreover, with the printer 10 which pertains to first embodiment, in the event that the user wishes to check the subject or composition of an image, a preview image or the original image can be displayed on the display unit 11. The display adjustment process performed for the purpose of real preview display is typically a color matching process accompanied by a color conversion process that requires some processing time. Particularly in the case of an image processing device lacking high processing capability, such as the standalone type printer 10 of the present embodiment, the process may be time-consuming. Thus, by performing real preview display in response to a user request, in the event that the user simply wishes to check the subject or composition of an image, he or she may do so quickly.

With the printer 10 pertaining to first embodiment, display image data that reflects the image quality adjustment process condition can be generated independently (as a parallel process) of the print image data, simply by setting the printing condition, i.e. by setting the image quality adjustment process condition. The resolution of image data required display on the display unit 11 is typically lower than the resolution required of print image data. Moreover, image quality adjustment process condition set via the display unit 11 change frequency in some instances. Accordingly, it is possible to reduce the load associated with the image quality adjustment process, by performing the image quality adjustment process on low-resolution data to produce display image data for the purpose of display on the display unit 11, until the image quality adjustment process condition have been determined. Moreover, since display image data and print image data can be generated through parallel processing, a print image that has undergone a print image quality adjustment process can be obtained even without displaying a real preview image or preview image on the display unit 11.

### Image Processing According to Second Embodiment

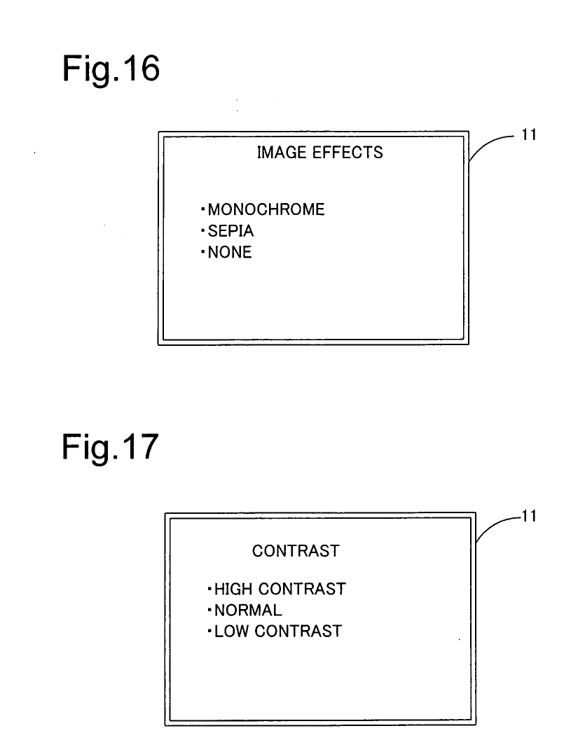

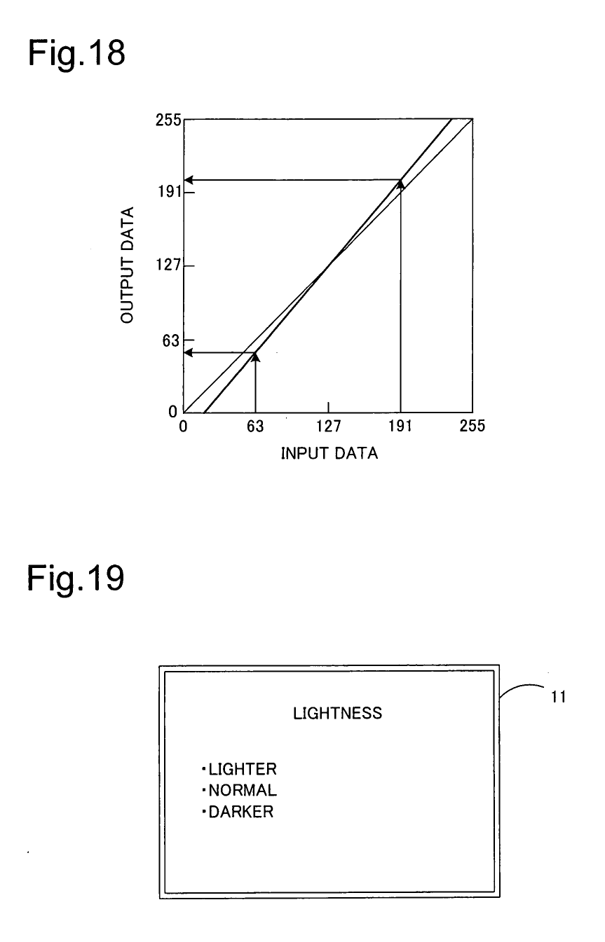

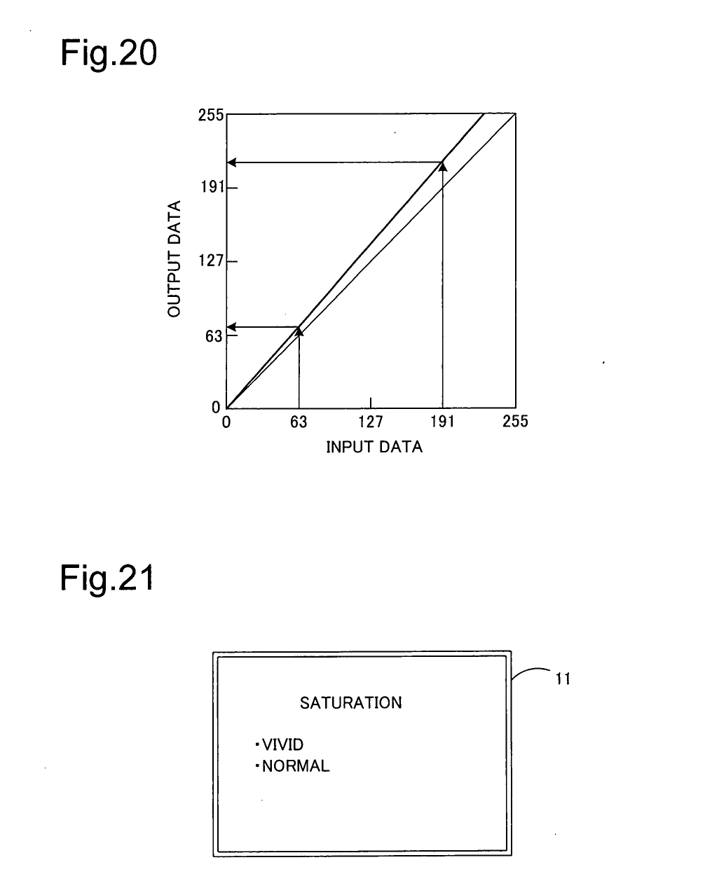

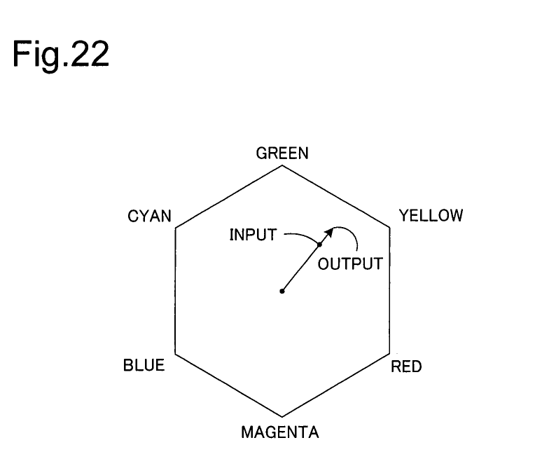

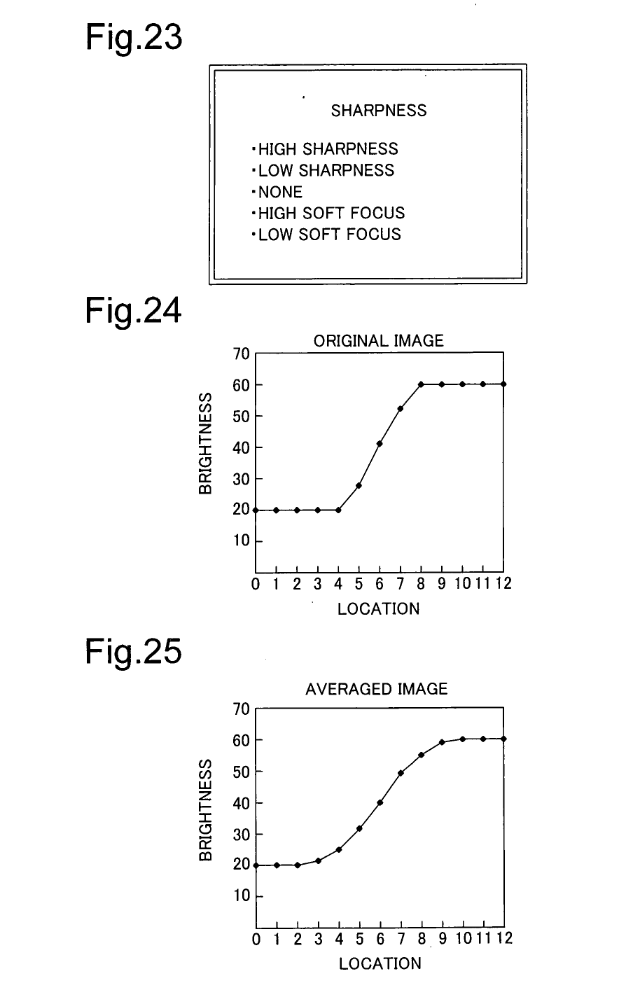

By way of a second embodiment, image processing according to second embodiment in the case of manually performing image quality adjustment process in the printer 10 pertaining to first embodiment will be discussed below with reference to FIGS. 16 through 27. FIG. 16 is an illustration of an exemplary display screen for setting an image effect by way of an image adjustment setting. FIG. 17 is an illustration of an exemplary display screen for setting contrast by way of an image adjustment setting. FIG. 18 is an illustration of an exemplary tone curve used during contrast correction. FIG. 19 is an illustration of an exemplary display screen for setting lightness by way of an image adjustment setting. FIG. 20 is an illustration of an exemplary tone curve used during lightness correction. FIG. 21 is an illustration of an exemplary display screen for setting saturation by way of an image adjustment setting. FIG. 22 is an illustration depicting the concept of saturation correction using a color wheel. FIG. 23 is an illustration of an exemplary display screen for setting sharpness by way of an image adjustment setting. FIGS. 24 through 27 illustrate the procedure of sharpness correction. Since the process routines of image processing have been discussed in first embodiment, the discussion here shall focus on the image quality adjustment process carried out manually.

With the image quality adjustment menu shown in FIG. 5 displayed on the display unit 11, when Image Effects is selected with the select key 12 and the execute key 14 is pressed, the Image Effects settings screen shown in FIG. 16 will be displayed on the display unit 11.

Similarly, with the image quality adjustment menu shown in FIG. 5 displayed on the display unit 11, when Contrast is selected and the execute key 14 is pressed, the Contrast settings screen shown in FIG. 17 will be displayed on the display unit 11. In the example of FIG. 17, it is possible to select either strong or weak contrast. In the event that strong contrast has been selected, contrast correction is performed by applying to the image data a tone curve like that shown in FIG. 18, for example. Specifically, by assigning a value greater than 1 to the slope of the tone curve (characteristic line) that passes through input/output values of 127, it is possible to obtain a well-modulated, high-contrast image with accentuated light and dark. On the other hand, where weak contrast is desired, a value less than 1 may be assigned to the slope of the tone curve that passes through input/output values of 127. In second embodiment as well, display image data and print image data constitute image data subjected independently to a image quality adjustment process in accordance with printing condition.

With the image quality adjustment menu shown in FIG. 5 displayed on the display unit 11, when Lightness is selected and the execute key 14 is pressed, the Lightness settings screen shown in FIG. 19 will be displayed on the display unit 11. In the example of FIG. 19, it is possible to select either Lighter or Darker image lightness (luminance). In the event that Lighter has been selected, Lightness correction will be performed by applying to the image data a tone curve like that shown in FIG. 20, for example. Specifically, by assigning a value greater than 1 to the slope of the tone curve (characteristic line) that passes through input/output values of 0, in areas ranging from shadow portions to highlight portions, input values will be greater than output values, i.e. they will become lighter, so that a light image may be obtained. On the other hand, where Darker has been selected, a value less than 1 may be assigned to the slope of the tone curve that passes through input/output values of 0. In this case, input values will be smaller than output values in areas ranging from shadow portions to highlight portions.

With the image quality adjustment menu shown in FIG. 5 displayed on the display unit 11, when Saturation is selected and the execute key 14 is pressed, the Saturation settings screen shown in FIG. 21 will be displayed on the display unit 11. In the example of FIG. 21, it is possible to select whether to make saturation Vivid. In the event that Vivid has been selected, input saturation values will be corrected so as to lie further away from the achromatic axis which is the center axis of the color wheel depicted in FIG. 22, for example. Saturation adjustment specifically involves performing HSI conversion of the target image data (which is RGB image data), extracting the saturation S, and increasing the extracted saturation S by prescribed magnitude, depending on the extent of enhancement. Next, inverse HSI conversion is performed on the using the saturation S increased by the prescribed magnitude, to obtain saturation-enhanced RGB image data.

With the image quality adjustment menu shown in FIG. 5 displayed on the display unit 11, when Sharpness is selected and the execute key 14 is pressed, the Sharpness settings screen shown in FIG. 23 will be displayed on the display unit 11. In the example of FIG. 23, it is possible to select strong or weak sharpness and strong or weak soft focus. In the sharpness process of the present embodiment, an unsharp mask is employed. The unsharp mask process involves carrying out analysis of the original image data (acquiring brightness values at each pixel location), smoothing the original image data, and applying the brightness differential between the original image data and the smoothed image data to the original image data. Settable parameters for the unsharp mask include the smoothing filter radius, an adaptive amount (intensity) specifying prescribed magnitude for the brightness differential, and a threshold value for limiting the applied differential value.

Analysis of the target image data gives a brightness differential at the edges like that depicted in FIG. 24. FIG. 24 shows the brightness distribution of the original image data. In the illustrations of FIGS. 24 through 27, pixel location is given on the horizontal axis, and pixel value (brightness value) is given on the vertical axis; the image signal (image data) is depicted in model form as a one-dimensional signal.

When the smoothing process has been carried out on the target image data, the brightness characteristics depicted in FIG. 25 will be obtained. The smoothing process may be carried out, for example, using a smoothing filter known as a moving average filter, to reduce the brightness differential among neighboring pixels.

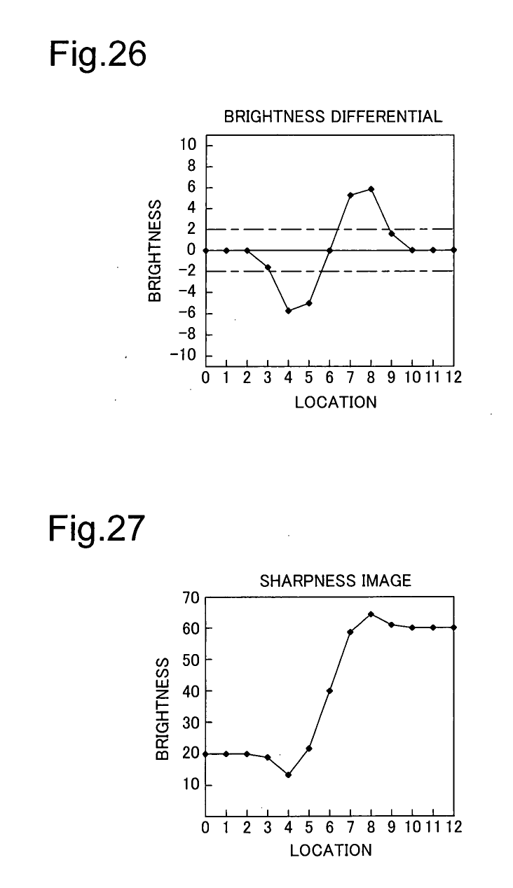

FIG. 26 depicts pixel value differential (brightness differential) at the same location in both the original image data shown in FIG. 24 and the smoothed image data shown in FIG. 25. The dashed lines in FIG. 26 indicate threshold values; only differential in excess of the threshold values will be added to the original image data. The image data to which brightness differential has been applied will have the brightness distribution depicted in FIG. 27. In the example of FIG. 27, brightness differential is enhanced at pixel locations 4 and 8, as a result of which there can be obtained image data with enhanced edges and boundaries.

In the event that a soft focus process is to be performed, the sign of the brightness differential may be reversed before application to the image data.

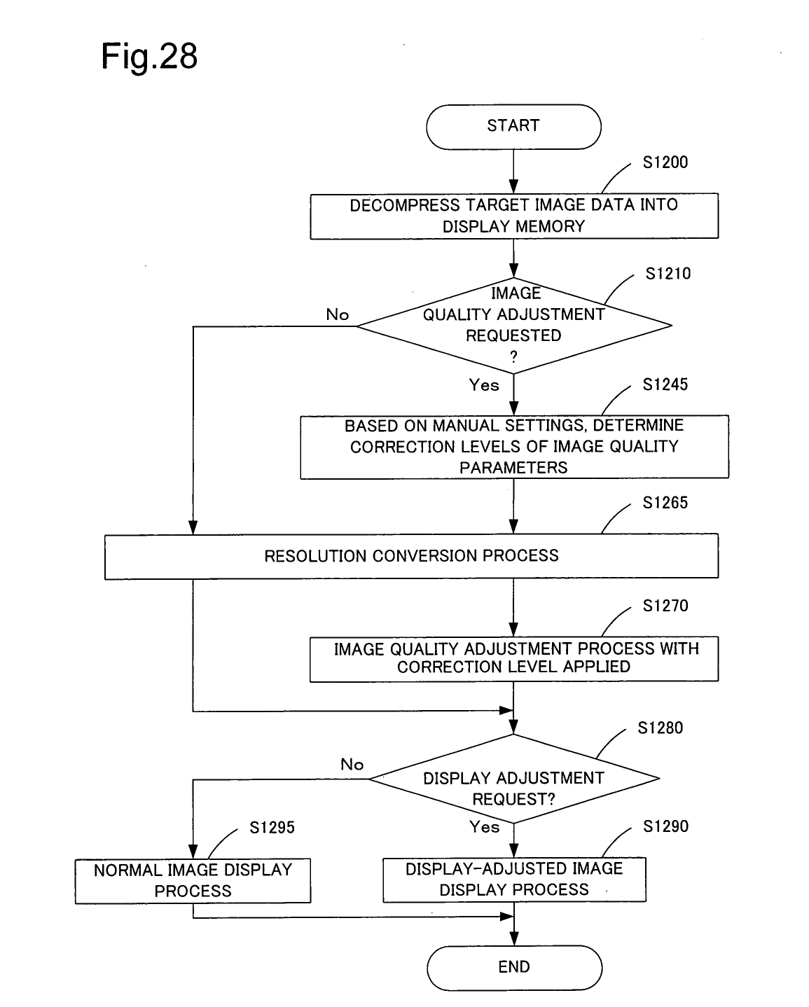

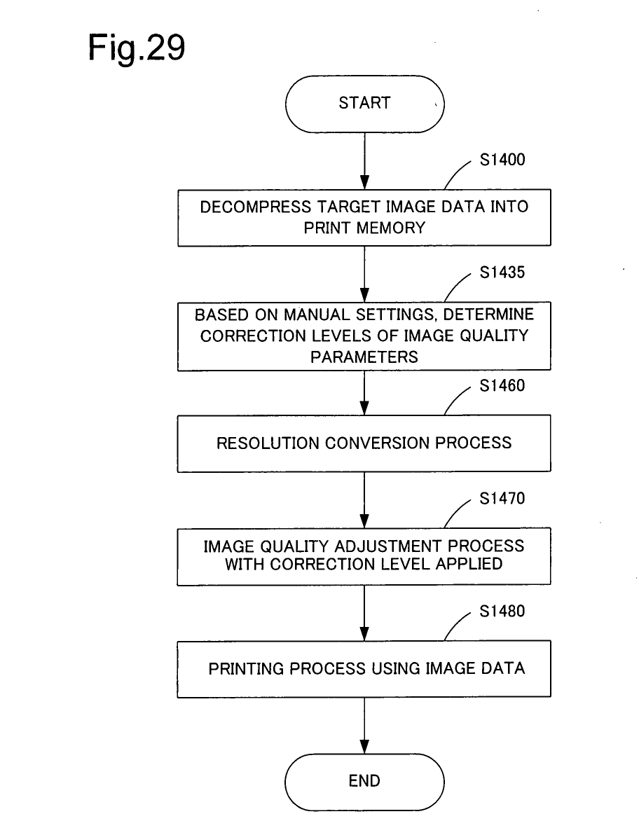

Subsequently, the processes depicted in FIG. 14, FIG. 28 and FIG. 29 are executed respectively, depending on the requested process. The processes depicted in FIG. 28 and FIG. 29 basically correspond to FIG. 6 and FIG. 15 which illustrate the processes performed in the first embodiment. Consequently, for processes that are similar to those performed in the first embodiment, identical step numbers will be assigned and the processes will not be discussed in detail, but steps unique to the second embodiment involving manual setting of printing condition (image quality adjustment conditions) will be discussed. FIG. 28 is a flowchart depicting the processing routine of the display control process with a preview process, executed in the second embodiment. FIG. 29 is a flowchart depicting the processing routine of the printing control process executed in the second embodiment.

In the event that display with a preview process has been requested on the display unit 11, in the display control process with preview process depicted in FIG. 28 the CPU 41 performs on the target image data the decompression process (Step S1200) and decides if there is a image quality adjustment request (Step S1210). In the event there is a image quality adjustment request (Step S1210: Yes), the CPU 41 determines correction levels for the various image quality parameters depending on the particular printing parameter settings made manually as described previously (Step S1245).

The CPU 41 performs the resolution conversion process (Step S1265), the image quality adjustment process to apply the correction levels (Step S1270), and the real preview image display process (Step S1290) or the preview image display process (Step S1295), then terminates the processing routine.

In the event that display without a preview process has been requested on the display unit 11, in the display control process without preview process depicted in FIG. 14 the CPU 41 performs the target image data decompression process (Step S1300), the resolution conversion process (Step S1310), and the original image display process (Step S1320), then terminates the processing routine.

Where a printing process in the print unit 20 has been requested, in the printing control process depicted in FIG. 29, the CPU 41 performs the target image data decompression process (Step S1400), and determines correction levels for the various image quality parameters depending on the particular printing parameter settings made manually as described previously (Step S1435).

The CPU 41 performs the resolution conversion process (Step S1460), the image quality adjustment process to apply the correction levels (Step S1470), and the printing process using the image data (Step S1480), then terminate the processing routine.

As described above, a manual image quality adjustment process in accordance with the second embodiment may be performed in the printer 10. Even where image quality adjustment conditions have been set manually, by means of real preview display, color of the display image displayed on the display unit 11 may be conformed or approximated to color of the print image, in response to a request by the user.

### Alternative Embodiments

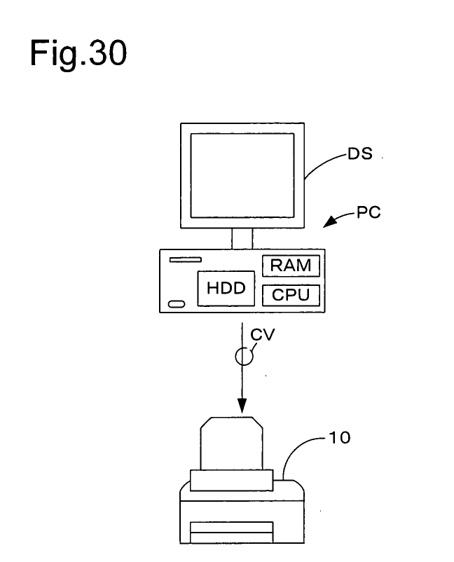

(1) While the preceding embodiments described the example of a multifunction printer 10 integrally provided with a display unit 11 and a print unit 20, image processing performed in the printer 10 could also be performed in a personal computer PC connected to the printer 10 by a connector cable CV, as illustrated in FIG. 30. In this case, print image data and print data, as well as display image data and display data, would be generated separately in the personal computer PC. The generated display image data would then be displayed on a display device DS connected to the personal computer PC, while the generated print image data would be printed onto print paper by the printer 10.

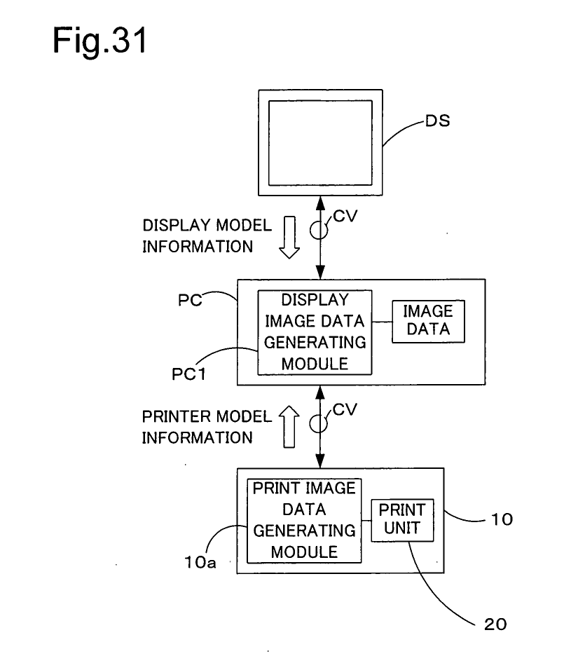

(2) The preceding embodiments could also be implemented in a system whereby print image data and print data are generated in the printer 10, while display image data and display data are generated in the personal computer PC respectively, as depicted in FIG. 31. FIG. 31 is an illustration depicting a system configuration example in a first alternative embodiment. In this configuration, the personal computer PC is provided, as functional portions realized through the CPU and the modules, with a display image data generating portion and memory portions 42, 43 for storing image data; the printer 10 are provided, as functional portions realized through the control circuit 40, with a print image data generating module 10a and a print unit 20. The personal computer PC acquires printer model information from the printer 10, and display model information from the display device DS.

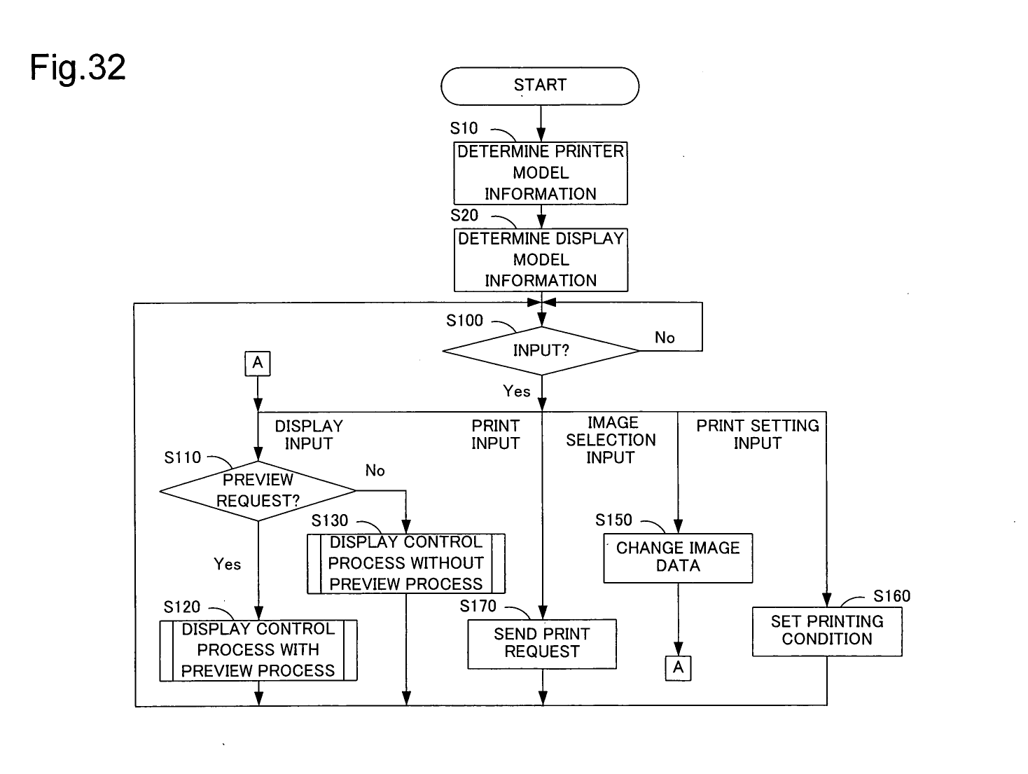

FIG. 32 is a flowchart depicting the processing routine of image processing executed in the PC in the first alternative embodiment. The flowchart shown in FIG. 32 is identical to the flowchart discussed previously in the first embodiment, except in that it is carried out in the personal computer PC, and except for Steps S100, S20, S100, and S170; accordingly, the remaining steps have been assigned the same step symbols, and are not described in detail.

When the processing routine is initiated, the personal computer PC acquires printer model information from the printer 10, and determines the printer model information to be used in subsequent processing (Step S10). The printer model information includes, for example, information relating to the model of the printer 10, the RGB-CMYK lookup table of the printer 10, or the version of the image processing program executed in the printer 10. By acquiring version information of the printer 10 image processing program or information relating to the lookup table, printing condition adapted to the connected printer 10 may be set in Step S160. The printer model information can be acquired all at once at timing subsequent to connection of the printer 10 to the personal computer PC, or acquired each time that the processing routine is executed.

The personal computer PC acquires display model information from the display device DS (driver), and determines the display model information to be used in subsequent processing (Step S20). The display model information includes, for example, the display device DS resolution, ICC profile information used in color matching, and so on. The display model information may be acquired all at once at timing subsequent to connection of the display device DS to the personal computer PC, or acquired each time that the processing routine is executed.

When the personal computer PC detects input via an input device, i.e. a mouse or keyboard, depending on the input it will execute a display input process (Steps S110-S130), the image selection input process (Step S150) discussed previously, and a print settings input process (Step S160).

In the display input process, in the event there is a preview request, print image processing executed during printing will be performed on the image data on the basis of the printing condition set in Step S160, and a resolution conversion process adapted to the display device DS is executed on the basis of the display model information. On the other hand, where there is no preview request, a color conversion process (color matching) and resolution conversion process is executed on the basis of the display model information, without performing image processing based on the printing condition.

In this alternative embodiment, since print requests are input to the personal computer PC, during the print input process a print request is sent from the personal computer PC to the printer 10 (Step S170). The print request includes the printing condition established in Step S160, and image data that has not undergone print image processing.

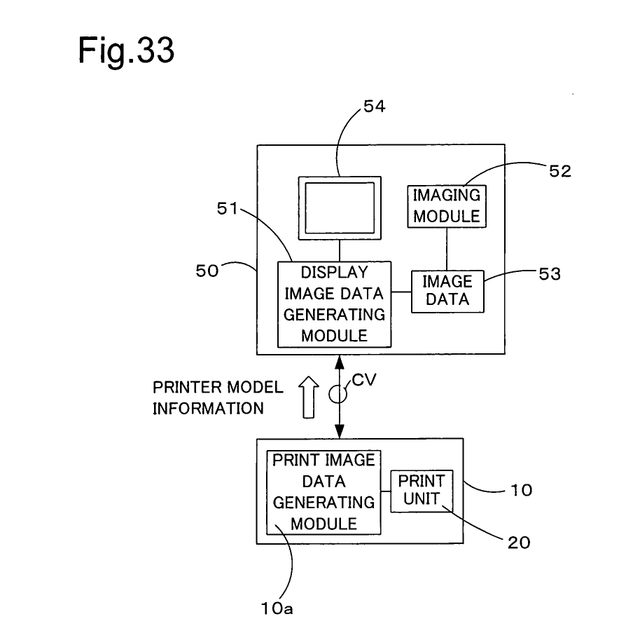

(3) The preceding embodiments could also be implemented in a system whereby the printer 10 and an independent display device 50, namely a digital still camera or image viewing device (image viewer) are connected directly via a cable CV, as shown in FIG. 33. Here, the independent display device 50 refers to a device having functions capable of independently generating and displaying display data from image data. FIG. 33 is an illustration depicting a system configuration example in a second alternative embodiment. Where the independent display device 50 is a digital still camera, the independent display device 50 is provided with an display image data generating module 51, an imaging module 52, and a detachable or non-detachable memory 53 for recording image data obtained through imaging. The printer 10 is provided with a print image data generating module 10a and a print unit 20, as functional modules realized through the control circuit 40.

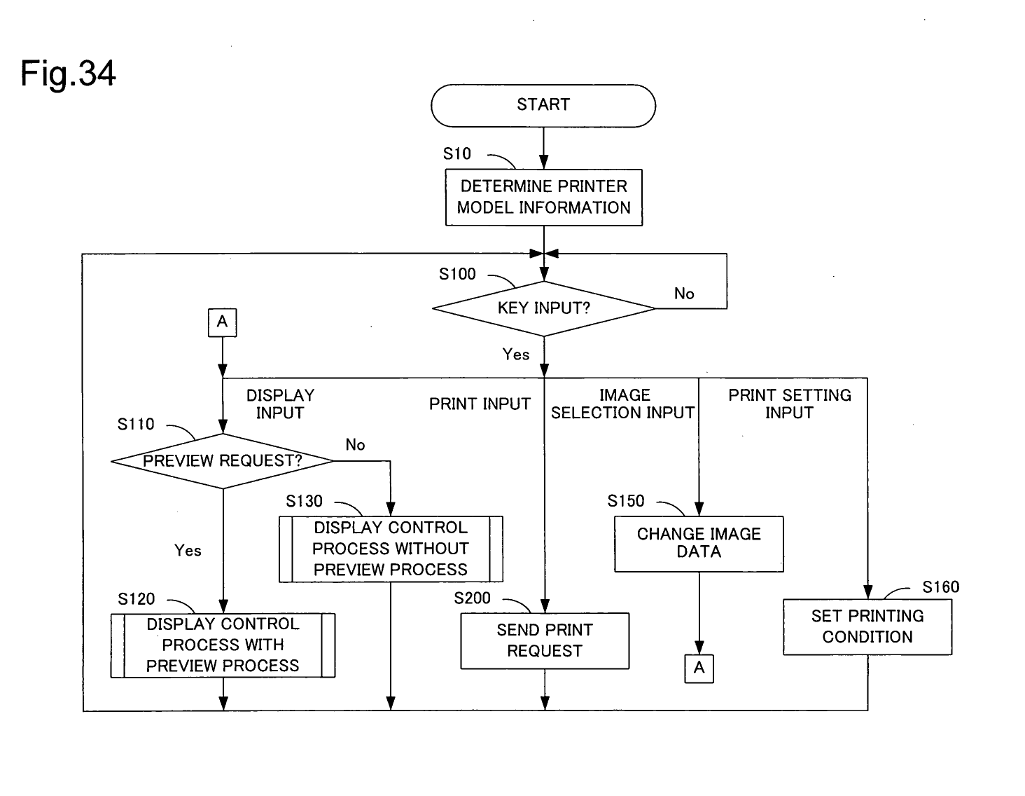

FIG. 34 is a flowchart depicting the processing routine of image processing executed in an independent display device 50 in the second alternative embodiment. The flowchart shown in FIG. 34 is identical to the flowchart discussed previously in the first embodiment, except in that it is executed by the independent display device 50, and except for Steps S10 and S170; accordingly, the remaining steps have been assigned the same step symbols, and are not described in detail.

When the processing routine is initiated, the independent display device 50 acquires printer model information from the printer 10, and determines the printer model information to be used in subsequent processing (Step S10). The printer model information includes, for example, information relating to the model of the printer 10, the RGB-CMYK lookup table of the printer 10, or the version of the image processing program executed in the printer 10. By acquiring version information of the printer 10 image processing program or information relating to the lookup table, printing condition adapted to the connected printer 10 may be set in Step S160. Since the independent display device 50 and the printer 10 are not always connected, in preferred practice printer model information will be acquired each time that the independent display device is connected to the printer 10. Frequently used printer model information may be stored in the independent display device 50.

When the independent display device 50 detects hard or soft key input, depending on the input the independent display device 50 executes a display input process (Steps S110-S130), the image selection input process (Step S150) discussed previously, or a print settings input process (Step S160).

In the display input process, in the event there is a preview request, print image processing will be performed on the image data on the basis of the printing condition set in Step S160, and a resolution conversion process adapted to the resolution of the display unit is executed. On the other hand, where there is no preview request, a color conversion process (color matching) and resolution conversion process adapted to the display unit is executed without performing image processing based on the printing condition.

In this alternative embodiment, since print requests are input to the independent display device 50, during the print input process a print request is sent from the independent display device 50 to the printer 10 (Step S200). The print request includes the printing condition established in Step S160, and image data that has not undergone print image processing.

(4) The image processing which pertains to the present embodiment can also be realized as a compute-readable medium, e.g. a CD-ROM, DVD-ROM, or HDD, having an image processing program recorded thereon.

(5) In the preceding embodiments, no paper type setting is available when setting the printing condition in the display adjustment process; however, the color conversion table used display adjustment could be modified according to paper type. Typically, in the color matching process, since color drift of achromatic color will be readily noticeable, a more effective display adjustment process can be carried out by bringing the color balance of display image data into approximation to or agreement with the color balance of print image data, with reference to the white color (ground color) of the particular print paper (paper type).

(6) The procedure print parameter input and the procedure for preview display selection in the preceding embodiments are merely exemplary, and may take various other forms. For example, a button for selecting automatic image quality adjustment could be provided, or buttons for saving and recalling manual image quality adjustment conditions frequently used by the user could be provided. Preview display need not rely on the preview display key 15, but could instead be set from a menu displayed on the display unit 11. Alternatively, a real preview display key could be provided in addition to the preview display key, so as to permit direct selection of real preview display. Key operation can be simplified thereby.

(7) In the preceding embodiments, the preset automatic image quality adjustment process or manual image quality adjustment process is executed even in instances where real preview display has not been requested; however, it would be acceptable to instead execute the preset automatic image quality adjustment process or manual image quality adjustment process only in instances where real preview display has been requested. In the event that real preview display has not been requested, the display image displayed on the display unit 11 will have different color reproduction from the print image, so it will not be possible for the user to verify the color reproduction afforded in the printed results, even if image quality adjustment has been performed. Consequently, the image display speed could be increased by omitting image quality adjustment.

(8) In the preceding embodiments, requests for real preview display are input to the printer 10 through the real preview display key 15; however, it would be acceptable to instead display on the display unit 11 a display image subjected to real preview display for print check purposes, when the print key 13 is pressed. In this case, in response to the print request operation performed by the user, i.e. pressing the print key 13, a display image reflecting the color reproduction that will be obtained with the printed results can be checked on the display unit 11.

(9) The set preview display requests or printing condition may be applied to all target image data until a Cancel instruction is input, or applied only to target image data displayed on the display unit 11.

While the present invention has been described herein in terms of certain preferred embodiments, the embodiments set forth herein are intended merely as an aid to understanding the invention, and should not be construed as limiting the invention in any way. Various modifications and improvements are possible without departing from the spirit of the invention, and these equivalents shall be considered to lie within the scope of the invention.

What is claimed is:

1. An image processing device connected to a display device and a printing device, the image processing device comprising:
an image data acquiring module that acquires image data;
a setting module that sets a print image quality adjustment condition that is a condition for adjusting image quality for a print image;
a print image data generating module that performs a image quality adjustment process on the acquired image data on the basis of the set print image quality adjustment condition, and generates print image data;
a display image data generating module that performs a image quality adjustment process on the acquired image data on the basis of the set print image quality adjustment condition, and generates display image data;
a display image adjusting module that adjusts the display image data so as to conform or approximate characteristics of a display image reproduced by the display device using the display image data to characteristics of a print image reproduced by the printing device using the print image data; and
a display control module that displays an image on the display device, using the adjusted display image data.

2. The image processing device according to claim 1 wherein adjustment of the display image data by the display image adjusting module is performed in the event that printed results confirmation display has been requested.

3. The image processing device according to claim 2 wherein in the event that printed results confirmation display is not requested,
the display image data generating module generates unadjusted display image data, without image quality adjustment on the basis of the set print image quality adjustment condition; and
the display control module will display an image on the display device using the unadjusted display image data.

4. The image processing device according to claim 2 wherein in the event that printed results confirmation display is not requested, the display control module displays an image on the display device, using the generated display image data.

5. The image processing device according to claim 1 wherein the print image quality adjustment condition includes an automatic image quality adjustment condition adapted to conform oe approximate a characteristic of a print image to a standard characteristic, or a manual image quality adjustment condition arbitrarily adjusting a characteristic of a print image; and
adjustment of the display image data by the display image adjusting module is performed in the event that either the automatic image quality adjustment condition or the manual image quality adjustment condition has been set, and printed results confirmation display has been requested.

6. The image processing device according to claim 1 wherein adjustment by the display image adjusting module involves a color matching process for conforming or approximating gray balance of the display image to gray balance of the print image.

7. The image processing device according to claim 6 wherein
adjustment by the display image adjusting module is performed in a manner depending on the print paper used in the printing device.

8. The image processing device according to claim 1 further comprising a printing control module that, in the event a print request is detected, uses the print image data generated by the print image data generating module to print an image by the printing device.

9. The image processing device according to claim 1 wherein
the image processing device is integrally furnished with the display device and the printing device.

10. An image processing method for image data, comprising:
acquiring image data;
acquiring a print image quality adjustment condition that is a condition for image quality adjustment for a print image;
on the basis of the acquired print image quality adjustment condition, performing a image quality adjustment process on the acquired image data and generating display image data;
adjusting the display image data in order to conform or approximate characteristics of a display image reproduced by the display device using the display image data to characteristics of a print image reproduced by the printing device using print image data that has been derived by applying the acquired print image quality adjustment condition to the acquired image data; and
using the adjusted display image data to display an image on a display device.
